(19) United States
(12) Patent Application Publication
(10) Pub. No.: US 2018/0330866 A1
(43) Pub. Date: Nov. 15, 2018

(54) REACTOR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Takashi Takada, Yokkaichi, Mie (JP); Shintaro Nanbara, Yokkaichi, Mie (JP); Kazushi Kusawake, Yokkaichi, Mie (JP)

(21) Appl. No.: 15/774,104

(22) PCT Filed: Dec. 2, 2016
(86) PCT No.: PCT/JP2016/085979

§ 371 Date: May 7, 2018

(30) Foreign Application Priority Data
Dec. 10, 2015 (JP) 2015-241650

(51) Int. Cl. H01F 27/26; H01F 37/00; H01F 27/02; H01F 27/32; H01F 27/08

(52) U.S. Cl. CPC H01F 27/26; H01F 37/00; H01F 27/08; H01F 27/324; H01F 27/02

(57) ABSTRACT

A reactor including: a coil that includes a winding portion that is constituted by a plurality of turns formed by spirally winding a winding wire; a magnetic core that includes a portion that is located in the winding portion; a casing that houses a combined body that includes the coil and the magnetic core; and a filling material that contains resin and fills the casing, wherein the winding portion includes an exposed portion that protrudes from an opening edge of the casing, the filling material includes an embedding portion in which a portion of the combined body is embedded and that has a surface located below or at the same level as the opening edge of the casing, and turn interposed portions that are interposed between the turns in the exposed portion, and surfaces of the turn interposed portions are located above a surface of the embedding portion.

### CROSS-REFERENCE TO RELATED APPLICATIONS

This application is the U.S. national stage of PCT/JP2016/085979 filed Dec. 2, 2016, which claims priority of Japanese Patent Application No.

JP 2015-241650 filed Dec. 10, 2015.

### TECHNICAL FIELD

The present disclosure relates to a reactor.

### BACKGROUND

A reactor is one type of circuit component that performs a voltage step-up operation or step-down operation. As a reactor that is used in a converter mounted on a vehicle such as a hybrid vehicle, JP 2013-145850A discloses a reactor in which a combined body composed of; a coil that includes a pair of winding portions (coil elements) formed by spirally winding a winding wire; and a ring-shaped magnetic core is housed in a casing, and furthermore, the casing is filled with a sealing resin. JP 2013-145850A discloses that heat dissipation properties can be improved by exposing the upper surfaces of the winding portions from the sealing resin, the upper surfaces being located on the casing's opening side, and that it is possible to allow the winding wire to be easily connected to a metal terminal part by exposing an end portion of the winding wire from the sealing resin.

### SUMMARY

The reactor according to the present disclosure includes a coil that includes a winding portion that is constituted by a plurality of turns formed by spirally winding a winding wire; a magnetic core that includes a portion that is located in the winding portion; a casing that houses a combined body that includes the coil and the magnetic core; and a filling material that contains resin and fills the casing. The winding portion includes an exposed portion that protrudes from an opening edge of the casing, and the filling material includes an embedding portion in which a portion of the combined body is embedded and that has a surface located below or at the same level as the opening edge of the casing, and turn interposed portions that are interposed between the turns in the exposed portion, and surfaces of the turn interposed portions are located above a surface of the embedding portion.

### BRIEF DESCRIPTION OF DRAWINGS

FIG. 1 is a schematic perspective view of a reactor according to a first embodiment.

FIG. 2 is a vertical cross-sectional view of the reactor according to the first embodiment along a cutting line (II)-(II) shown in FIG. 1.

FIG. 3 is a lateral cross-sectional view of the reactor according to the first embodiment along a cutting line (III)-(III) shown in FIG. 1.

FIG. 4 is an exploded perspective view of a combined body that is provided in the reactor according to the first embodiment.

### DETAILED DESCRIPTION OF PREFERRED EMBODIMENTS

### Problems to be Solved by Present Disclosure

A reactor provided with a casing is desired to be further downsized, with excellent insulation properties being provided.

When the dimension of a constituent element of the reactor in a depth direction of the casing is referred to as the height of the element, if the upper surfaces of the winding portions of the coil are exposed from the sealing resin as described above, the filling height of the sealing resin can be equal to the height of the upper surfaces of the winding portions. The height of the casing can be reduced depending on the filling height, and the reactor can be downsized due to a reduction in the height of the reactor. However, if an end portion of the winding wire is configured to protrude from an opening edge of the casing and a metal terminal part is attached thereto, the height of the reactor including the protruding portion of the end portion of the winding wire and the metal terminal part is large. Therefore, there is a demand to further downsize the reactor.

For example, if the depth of the casing is reduced such that approximately half the combined body is exposed from the casing, and thus the height of the casing is sufficiently reduced, the height of the reactor is not affected by the height of the casing. However, with such a shallow casing, a large area of the coil is exposed from the sealing resin. Since sealing resin is not interposed between turns in the exposed area, there is the risk of insulation properties being degraded, especially between turns. This is because, if sealing resin is not interposed between turns, turns that are adjacent to each other rub against each other due to vibrations generated during the use of the reactor, for example. However, insufficient study has been conducted regarding a filling material that fills the casing and that can also fill gaps between turns in the exposed area of the coil in cases where, although the reactor is provided with a casing, a portion of the coil is exposed from the casing.

In the process of manufacturing a reactor, if a resin having high viscosity is used as a filling material, for example, it is difficult to fill the filling material into the gaps between turns in the above-described exposed area, even while performing evacuation. This is because the gaps between turns are usually very narrow, and in addition, since the gap between the coil and the casing is narrow due the reactor being downsized, resin having high viscosity can be considered to be unlikely to flow into the gaps between turns, from an area around the coil. Even with a resin having relatively low viscosity, a filling material that contains a filler with excellent thermal conductivity is likely to have high viscosity, and such a filling material can be considered to be unlikely to flow into the gaps between turns in the above-described exposed area. If filling with a filling material is performed in atmospheric air, there is substantially no need to perform atmosphere control, and thus the manufacturability of the reactor can be high. However, the above-described filling material with high viscosity is likely to enclose bubbles. Bubbles thus enclosed may also lead to the degradation of the insulation between turns, and the degradation of the insulation between the coil and the casing. Furthermore, bubbles thus enclosed worsen the external appearance, such as by making the surface uneven.

Therefore, the present disclosure aims to provide a downsized reactor with excellent insulation properties.

The reactor according to the present disclosure has excellent insulation properties and is downsized.

First, aspects of the present disclosure will be listed and described.

A reactor according to one aspect of the present disclosure includes: a coil that includes a winding portion that is constituted by a plurality of turns formed by spirally winding a winding wire; a magnetic core that includes a portion that is located in the winding portion; a casing that houses a combined body that includes the coil and the magnetic core; and a filling material that contains resin and fills the casing. The winding portion includes an exposed portion that protrudes from an opening edge of the casing, and the filling material includes an embedding portion in which a portion of the combined body is embedded and that has a surface located below or at the same level as the opening edge of the casing, and turn interposed portions that are interposed between the turns in the exposed portion, and surfaces of the turn interposed portions are located above a surface of the embedding portion.

The above-described reactor has a relatively small height and is downsized for the following reasons.

A portion (the exposed portion) of the winding portion of the coil protrudes from the opening edge of the casing, and therefore it can be said that the depth of the casing is smaller than the height of the winding portion housed in the casing. Consequently, it can be said that the height of the casing is smaller than the height of the winding portion. Therefore, the height of the above-described reactor is substantially unaffected by the height of the casing, and is equal to the height of the winding portion. Depending on the direction in which an end portion of the winding wire is drawn out, the height of the reactor in a state where a metal terminal part is attached to the end portion of the winding wire can be approximately the same as the height of the above-described winding portion, and the height of the reactor, even including the metal terminal part, is small, and the reactor can be downsized.

Also, the above-described reactor has excellent insulation properties for the following reasons.

The filling height of the filling material depends on the depth of the casing. The casing is shallow as described above, and it can be said that a portion (the exposed portion) of the winding portion of the coil is exposed not only from the casing but also from the filling material (the embedding portion). However, portions (the turn interposed portions) of the filling material are present between the turns in the exposed portion. In addition, the surfaces of the turn interposed portions are located above the surface of a portion (the embedding portion) of the filling material that covers a portion of the combined body. Therefore, it can be said that a sufficient amount of filling material is present between the turns in the exposed portion. Also, the embedding portion and the turn interposed portions are continuous, and therefore the embedding portion improves the rigidity of the turn interposed portions. This is because such turn interposed portions sufficiently prevent turns that are adjacent to each other from coming into contact with each other. In particular, if the turn interposed portions are present in entire areas between the turns in the exposed portion, i.e. if the filling material is present in the entire width of the winding wire that forms the turns, continuously in the circumferential direction of the winding portions, it is possible to more reliably prevent turns that are adjacent to each other from coming into contact with each other, and insulation between the turns is further improved.

Also, the above-described reactor has excellent heat dissipation properties for the following reasons.

As described above, portions of the filling material (the turn interposed portions) are present between the turns in the exposed portion, and these turn interposed portions are continuous with the embedding portion. Therefore, heat from the coil can be conducted to an installation target such as a cooling base to which the casing is attached, via the turn interposed portions, the embedding portion, and the casing, in this order. If the filling material is present in entire areas between the turns in the exposed portion, and furthermore, if the casing is made of a material that has excellent thermal conductivity such as metal, and if the filling material contains a filler that has excellent thermal conductivity, the reactor has further improved heat dissipation properties. Also, a portion of the winding portion of the coil protrudes from the casing, and therefore, if the reactor is used in an environment in which atmospheric gas circulates (e.g. a fan is used), the exposed portion can be cooled.

In the above-described reactor, although a portion (the exposed portion) of the winding portion of the coil is exposed from a portion (the embedding portion) of the filling material that fills the casing, other portions (the turn interposed portions) of the filling material are sufficiently present between the plurality of turns included in the winding portion, and are also continuous with each other. Therefore, one example of the filling material is a material that is likely to fill very narrow gaps such as the gaps between the turns in the manufacturing process. One example of such a filling material with excellent filling properties is a material that has excellent wettability (detailed later) to a constituent element of the reactor such as the coil. If the above-described reactor includes a filling material that has excellent wettability, the filling material is less likely to enclose bubbles even if filling is performed in atmospheric air. Therefore, it is possible to prevent insulation between the turns from degrading due to bubbles being contained in the filling material, and insulation between the coil and the casing from degrading. Also from this point of view, the reactor has excellent insulation properties. Also, since substantially no bubbles are contained, the reactor has an excellent external appearance. Furthermore, if the filling material contains a resin with excellent wettability, the filling material is likely to have excellent wettability, and even if the filling material contains the above-described filler or filling is performed in atmospheric air, such a filling material is less likely to enclose bubbles and filling with it can be easily performed in a desirable manner (see the test example described later). The reactor can have excellent heat dissipation properties due to the filler being contained, and also the reactor has excellent manufacturability due to a decrease in yield caused by a poor appearance being suppressed.

In one aspect of the above-described reactor, a protruding height of the exposed portion relative to the surface of the embedding portion may be no greater than a width of the winding wire. The width of the winding wire is the length of the long sides of the minimum rectangle that envelops a lateral cross section of the winding wire. For example, if the rectangle is an oblong, the length of the long sides is equal to the width of the winding wire, and if the rectangle is a square, the length of each side is equal to the width of the winding wire. For example, the width of the winding wire is the length of the long sides if the winding wire is a flat wire that has a rectangular lateral cross section, and is the diameter if the winding wire is a round wire that has a circular lateral cross section.

Since the protruding height of the exposed portion in the above-described aspect is relatively small, namely no greater than the width of the wiring, the height of the embedding portion (the filling height) is sufficiently large, a large portion of the winding portion of the coil is surrounded by the embedding portion, and thus insulation between the coil and the casing is excellent. Also, the maximum distance between the surface of the exposed portion and the surface of the embedding portion is relatively small, namely no greater than the width of the winding wire, and it can be said that the entirety of the exposed portion is located close to the surface of the embedding portion. Therefore, in the manufacturing process, if the above-described filling material with excellent wettability is used, for example, the gaps between the turns in the exposed portion can be easily filled with the filling material due to capillary action or the like. Also, it is easier to fill the gaps between the turns in the winding portion with the filling material continuously in the circumferential direction of the winding portion, and it is easier to fill the gaps between the turns in the exposed portion in the entirety of the area from the inner circumferential surface to the outer circumferential surface of the winding portion, for example. As a result, it is possible to realize a reactor in which the turn interposed portions are sufficiently present between the turns. Therefore, the reactor according to the above-described aspect has excellent insulation properties, is downsized, and also has excellent heat dissipation properties and manufacturability.

In one aspect of the above-described reactor, the filling material may contain an epoxy resin or a urethane resin, and a surface energy control additive.

This filling material has excellent wettability to a constituent element of the reactor such as the coil, in the process of manufacturing the reactor, due to the surface energy control additive being contained, and has excellent wettability even when the filling material contains the above-described filler, for example. Therefore, the filling material is likely to fill very narrow gaps such as the gaps between the turns and the gap between the coil and the casing, and also the filling material is less likely to enclose bubbles even when filling is performed in atmospheric air. It is easier to fill the gaps between the turns in the winding portion with the filling material continuously in the circumferential direction of the winding portion, and it is easier to fill the gaps between the turns in the exposed portion in the entirety of the area from the inner circumferential surface to the outer circumferential surface of the winding portion, for example. Thus, it is possible to realize a reactor in which the turn interposed portions are sufficiently present between the turns. Therefore, the reactor according to the above-described aspect has excellent insulation properties, is downsized, and has excellent heat dissipation properties, and also the filling material has excellent filling properties. Therefore, manufacturability is also excellent. Furthermore, the above-described filling material is unlikely to split even when it is subjected to a thermal cycle or the like.

In one aspect of the above-described reactor, a gap between an outer circumferential surface of the winding portion and a bottom portion side area of the casing may be wider than a gap between the outer circumferential surface of the winding portion and an opening side area of the casing.

In the above-described aspect, the bottom portion side area of the casing, which cannot be easily evacuated, is wider than the opening side area. Therefore, it is easier to fill the casing with the filling material (the embedding portion) in the manufacturing process. In particular, the filling material is less likely to enclose bubbles even when filling is performed in atmospheric air. Therefore, in the above-described aspect, substantially no bubbles or the like are present in the embedding portions between the coil and the casing, and insulation between the coil and the casing is improved. Thus, the reactor has excellent insulation properties, is downsized, and also the filling material has excellent filling properties. Therefore, manufacturability is also excellent.

In one aspect of the above-described reactor, the reactor may further include an insulating layer that is interposed between the wiring portion and an inner bottom surface of the casing, and that contains an insulative material that has a thermal conductivity that is greater than or equal to 2 W/m·K.

In the above-described aspect, the insulating layer is interposed between the winding portion of the coil and the inner bottom surface of the casing, and insulation properties can be improved even when the inner bottom surface of the casing on which the combined body is mounted is made of metal. Also, since the insulating layer includes an insulative material with high thermal conductivity, the insulating layer has excellent thermal conductivity. Heat from the coil can be desirably conducted to the bottom portion of the casing via the insulating layer. In particular, if the bottom portion of the casing is made of metal, heat from the coil can be desirably conducted to the outside. Therefore, the reactor according to the above-described aspect has excellent insulation properties, is downsized, and also has excellent heat dissipation properties.

The following specifically describes an embodiment of the present disclosure with reference to the drawings. Elements having the same name are denoted by the same reference signs throughout the drawings.

### First Embodiment

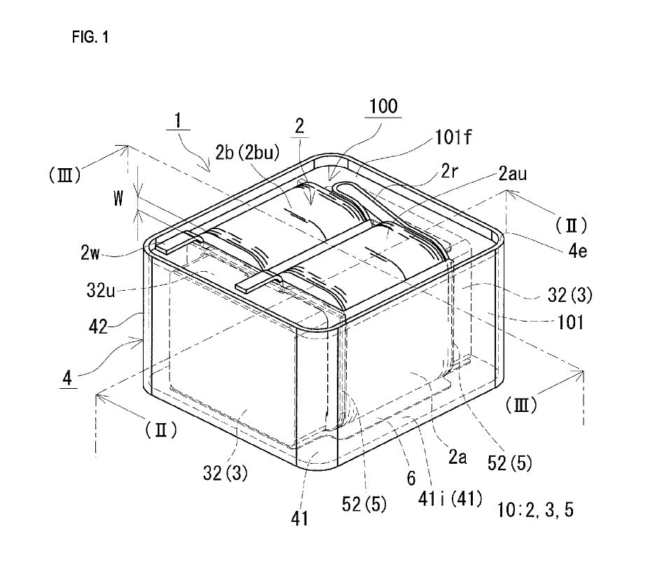

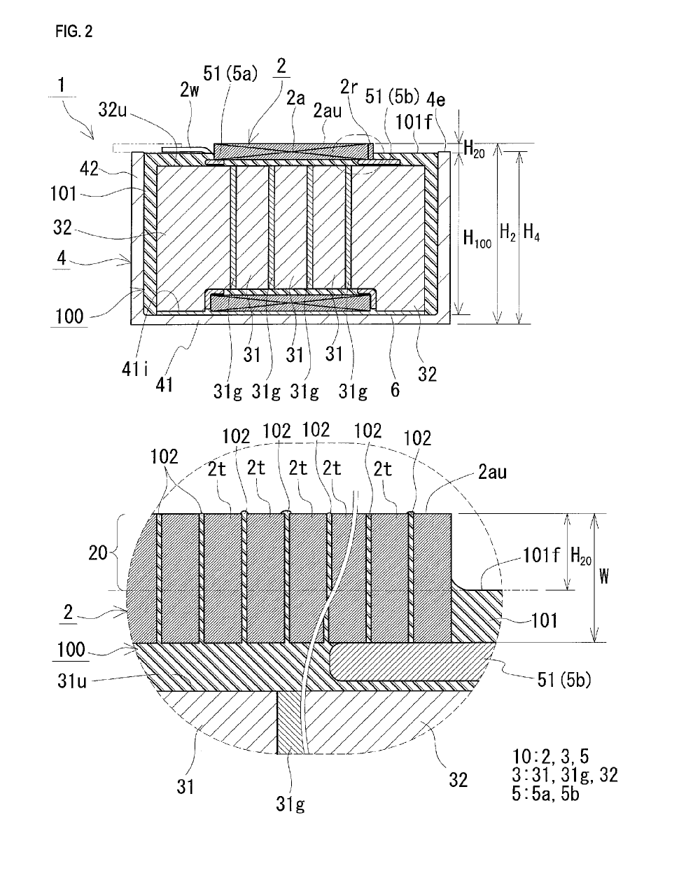

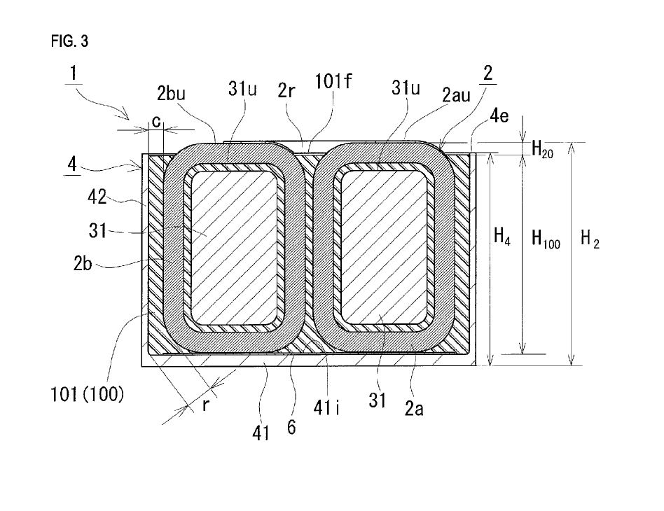

A reactor 1 according to a first embodiment will be described with reference to FIGS. 1 to 4. FIG. 2 is a vertical cross-sectional view of the reactor 1 along a plane that is parallel with the axis of a winding portion 2a that is included in a coil 2. FIG. 3 is a lateral cross-sectional view of the reactor 1 along a plane that is orthogonal to the axes of a pair of winding portions 2a and 2b and is parallel with a direction in which the winding portions 2a and 2b are arranged side by side.

### Overall Configuration

As shown in FIG. 1, the reactor 1 according to the first embodiment includes: the coil 2 that includes the pair of winding portions 2a and 2b formed by spirally winding a winding wire 2w; a magnetic core 3 that includes portions that are located inside the winding portions 2a and 2b; a casing 4 that is box-shaped and houses a combined body 10 that includes the coil 2 and the magnetic core 3; and a filling material 100 that fills the casing 4. The filling material 100 includes an embedding portion 101 in which a portion of the combined body 10 is embedded. The combined body 10 and the casing 4 are fixed by the embedding portion 101, integrally with each other.

The casing 4 is attached to an installation target such as a converter casing (not shown) when the reactor 1 is to be used. If the installation target has a cooling structure, heat from the coil 2 or heat from the magnetic core 3 generated when the reactor 1 is used is conducted from the filling material 100 to the installation target located outside the casing 4, via the casing 4, and thus the coil 2 and so on are cooled by the installation target. Although FIG. 1 shows, as an installed state, a state in which a bottom portion 41 of the casing 4 faces downward and an opening edge 4e of the casing 4 faces upward, the reactor 1 may be installed such that the bottom portion 41 and the opening edge 4e face to the left and the right. In the following description, the dimension of each constituent element of the reactor 1 in the depth direction of the casing 4 (the top-bottom direction) when the reactor 1 is in the installed state shown in FIG. 1 is referred to as the height of the element.

In a state where the combined body 10 is housed in the casing 4, one feature of the reactor 1 according to the first embodiment is that a height H₄ (FIGS. 2 and 3) of the casing 4 is relatively small and portions of the winding portions 2a and 2b of the coil 2 protrude from the opening edge 4e of the casing 4. A filling height H₁₀₀ (the same as above) of the embedding portion 101 that fills the casing 4 depends on the height H₄ of the casing 4. Therefore, the filling height H₁₀₀ is smaller than a height H₂ (the same as above) of the winding portions 2a and 2b in the state of being housed in the casing 4. Specifically, a surface 101f of the embedding portion 101 is located at the same level as or below the opening edge 4e of the casing 4, and is located below opening-side surfaces 2au and 2bu (upper surfaces in this example) of the winding portions 2a and 2b (FIGS. 2 and 3), the opening-side surfaces 2au and 2bu being located on the casing 4's opening side. Therefore, portions of the winding portions 2a and 2b also protrude from the surface 101f of the embedding portion 101. The surface 101f corresponds to a liquid surface that is formed by the filling material in the manufacturing process. Although portions of the winding portions 2a and 2b protrude from the casing 4 and the filling material 100 (the embedding portion 101) in this way, portions of the filling material 100 (turn interposed portions 102) are interposed between turns 2t in protruding portions (exposed portions 20) as shown in a dashed circle in FIG. 2, the embedding portion 101 and the turn interposed portions 102 are continuous with each other, and the surfaces of the turn interposed portions 102 are located at a level higher than the surface 101f of the embedding portion 101, each of which is one feature of the reactor 1.

The following describes overviews of the coil 2, the magnetic core 3, and the casing 4, which are main members of the reactor 1, and then describes the details of the filling material 100. Thereafter, modifications of the main members of the reactor 1 and other constituent members will be described.

### Coil

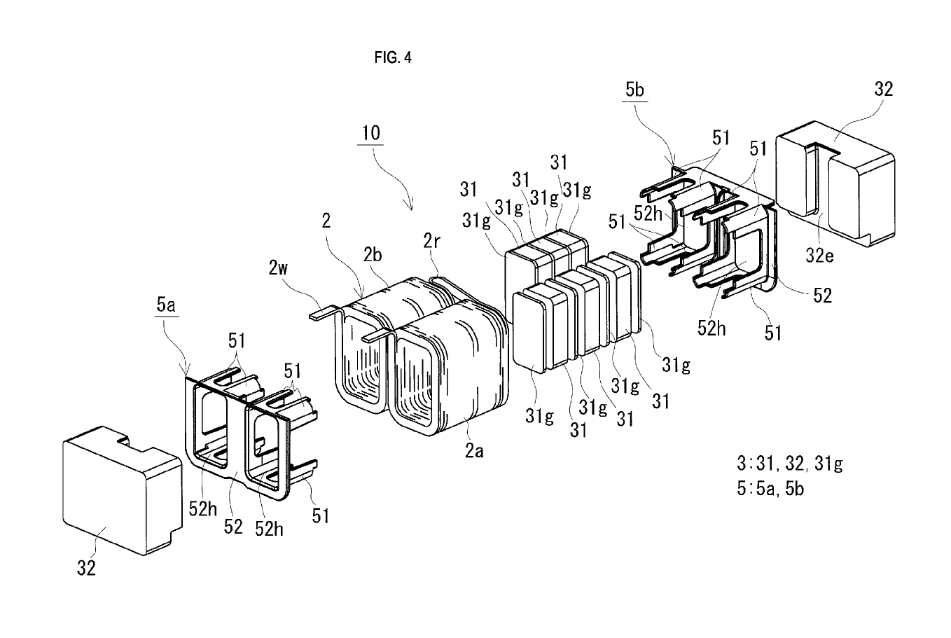

As shown in FIG. 4, the coil 2 includes: a pair of winding portions 2a and 2b that are constituted by a plurality of turns 2t that are formed by spirally winding one continuous winding wire 2w; and a coupling portion 2r that is constituted by a portion of the winding wire 2w and connects the winding portions 2a and 2b to each other. Each of the winding portions 2a and 2b in this example is a tubular member that has a rectangular end surface with rounded corners. The winding portions 2a and 2b are arranged in parallel (side by side) such that the axes thereof extend in parallel with each other. The winding wire 2w in this example is a coated flat wire (a so-called enameled wire) that includes: a conductor (copper or the like), which is a flat wire; and an insulative coating (polyamide or the like) that covers the outer circumferential surface of the conductor, and the winding portions 2a and 2b are edgewise coils.

In this example, the coil 2 is housed in the casing 4 such that the axes of the winding portions 2a and 2b of the coil 2 extend in parallel with an inner bottom surface 41i of the casing 4 (FIG. 2). Both end portions of the winding wire 2w are drawn out of the winding portions 2a and 2b in appropriate directions, and the insulative coating is removed from the leading end portions thereof. Thus, the metal terminal part (indicated by two-dot chain line in FIG. 2) is connected to the conductor. The coil 2 is electrically connected to an external device such as a power supply (not shown) via this metal terminal part.

In this example, the end portions of the winding wire 2w are drawn out such that the opening-side surfaces 2au and 2bu of the winding portions 2a and 2b of the coil 2 and the metal terminal part are substantially flush in a state where the metal terminal part is attached. Specifically, as shown in FIG. 2, the winding wire 2w is bent flatwise in the axial direction of the winding portions 2a and 2b, at a position that is close to, but lower than, the opening-side surfaces 2au and 2bu. The direction in which the winding wire 2w is drawn out, and the draw-out length by which the winding wire 2w is drawn out can be changed as appropriate. The draw-out length in this example is such that the end portions of the winding wire 2w do not reach the opening edge 4e of the casing 4 in a state where the combined body 10 is housed in the casing 4.

### Magnetic Core

As shown in FIG. 4, the magnetic core 3 in this example includes: a plurality of core pieces 31 and 32; and a plurality of gap members 31g that are interposed between core pieces 31 that are adjacent to each other, and between core pieces 31 and 32 that are adjacent to each other. The pair of core pieces 32, which are each U-shaped when seen from above in FIG. 4, are arranged such that the openings of the U shapes face each other, and a pair of stacked members, which are each constituted by core pieces 31 and gap members 31g that are stacked, are arranged side by side (in parallel) between the core pieces 32. With this arrangement, the magnetic core 3 is attached so as to have a ring-like shape, and forms a closed magnetic circuit when the coil 2 is excited. The core pieces 31, the gap members 31g, and portions of the U-shaped core pieces 32 (protruding portions described below) of the magnetic core 3 constitute portions that are located inside the winding portions 2a and 2b of the coil 2 as shown in FIG. 0.2. The remaining portions of the U-shaped core pieces 32 (blocks described below) constitute portions that protrude from the coil 2.

The core pieces 31 and 32 are mainly made of a soft magnetic material. The core pieces 31 and 32 are, for example, powder compacts formed by compression-molding a soft magnetic metal powder of iron or an iron alloy (an Fe—Si alloy, an Fe—Ni alloy, or the like) or coated powder that is composed of particles with insulative coatings, or molded members that are made of composite materials including soft magnetic powder and resin. In this example, the core pieces 31 and 32 are powder compacts. The gap members 31g are typically made of a material that has a relative permeability lower than that of the core pieces 31 and 32. For example, a nonmagnetic material such as alumina or resin is employed.

### Casing

As shown in FIGS. 1 and 2, the casing 4 is a container that houses the combined body 10 that includes the coil 2 and the magnetic core 3. The casing 4 protects the combined body 10 against mechanical factors and external environmental factors (e.g. corrosion protection), and also serves as a heat dissipation path for the combined body 10 when the casing 4 is made of a material with an excellent thermal conductivity, typically a metal.

Typically, the casing 4 includes: the bottom portion 41 that includes inner the bottom surface 41i on which the combined body 10 is mounted; and a side wall portion 42 that stands upright on the bottom portion 41 and surrounds the combined body 10, and is a box-shaped member that is open in a direction (upward in FIGS. 1 and 2) opposite to the bottom portion 41. The inner bottom surface 41i of the casing 4 in this example is a flat surface (FIGS. 2 and 3), and installation-side surfaces (surfaces opposite to the opening-side surfaces 2au and 2bu, lower surfaces in this example) of the winding portions 2a and 2b of the coil 2 can be arranged in parallel with the inner bottom surface 41i, so that a contact area between the coil 2 and the inner bottom surface 41i can be sufficiently large. Therefore, for example, the combined body 10 can be stably mounted, and heat dissipation properties can be improved.

The inner wall surface of the casing 4 is also a substantially flat surface, and as shown in FIG. 3, a gap r between the outer circumferential surface of each of the winding portions 2a and 2b of the coil 2 and a bottom portion 41-side area of the casing 4 is wider than a gap c between the outer circumferential surface of each of the winding portions 2a and 2b of the coil 2 and an opening-side area of the casing 4. The corners of the winding portions 2a and 2b in this example are rounded according to a predetermined bending radius R, and spaces that correspond to the bending radius R are provided between: bottom portion 41-side corners of the winding portions 2a and 2b, the bottom portion 41 being included in the casing 4; and corners of the casing 4 formed between the inner bottom surface 41i and the inner wall surface of the casing 4. These spaces are larger than spaces formed between portions, constituted by flat surfaces other than the corners, of the outer circumferential surfaces of the winding portions 2a and 2b, and the inner wall surface of the casing 4. Although the specific dimension of the spaces depends on the dimensions of the reactor 1, the gap c is set within the range of 1.5 mm to 2 mm inclusive, considering insulation between the coil 2 and the casing 4 that is made of metal and downsizing of the reactor 1, and the gap r is set to be greater than or equal to 1.8 mm, for example (the gap r>the gap c).

The casing 4 in this example is a metal box into which the bottom portion 41 and the side wall portion 42 are integrated. Generally, metal has higher thermal conductivity than resin. Therefore, the entirety of the casing 4 can be used as a heat dissipation path, which provides the reactor 1 with excellent heat dissipation properties. Note that the casing 4 may be provided integrally with a converter casing. Examples of metals that can constitute the casing 4 include aluminum and an alloy thereof.

In a state where the combined body 10 is housed in the casing 4, the height H₄ of the casing 4 is smaller than the height of the combined body 10 (which is equal to the height H₂ of the coil 2 in this example). The height H₄ of the casing 4 in this example is such that portions of the winding portions 2a and 2b of the coil 2, specifically the opening-side surfaces 2au and 2bu and portions in the vicinity thereof protrude from the opening edge 4e of the casing 4. Therefore, the winding portions 2a and 2b in this example have the opening-side surfaces 2au and 2bu and portions in the vicinity thereof as the exposed portions 20 that protrude from the opening edge 4e, and the opening edge 4e is provided such that the protruding height of the exposed portions 20 relative to the opening edge 4e is smaller than or equal to a width W of the winding wire 2w. The metal terminal part attached to an end portion of the winding wire 2w protrudes from the opening edge 4e of the casing 4 and can be easily positioned. Also, as described above, the metal terminal part is positioned so as to be substantially flush with the opening-side surfaces 2au and 2bu, and does not protrude from the coil 2 (see FIG. 2).

### Filling Material

The filling material 100 fills the casing 4, and carries out various functions. For example, the filling material 100 improves the strength and rigidity of the reactor 1 by integrating the combined body 10 with the casing 4, protects the combined body 10 against mechanical factors and external environmental factors (e.g. corrosion protection) by covering the combined body 10, improves insulation properties, and improves heat dissipation properties.

### Embedding Portion

In this example, as shown in FIGS. 1 to 3, portions of the combined body 10 housed in the casing 4 other than an end portion of the winding wire 2w of the coil 2 or portions of the winding portions 2a and 2b (the exposed portions 20) are embedded in the filling material 100 (the embedding portion 101) that is filled into the casing 4. The embedding portion 101 is continuously present so as to surround a portion of the combined body 10, and opening-side surfaces 32u, which protrude from the coil 2, of the core pieces 32 of the magnetic core 3 are embedded in the embedding portion 101, the opening-side surfaces 32u being located on the casing 4's opening side. Due to the presence of the embedding portion 101, most of the coil 2 and the entirety of the magnetic core 3 are integrated with the casing 4, and thus the strength and rigidity of the reactor 1 are improved. Therefore, noise and vibrations can be reduced. Also, since most of the coil 2 and the entirety of the magnetic core 3 are covered by the embedding portion 101, protection against mechanical factors can be desirably achieved.

The embedding portion 101 in this example covers the entirety of the area in which the core pieces 31 and 32 of the winding portions 2a and 2b are present. The surface 101f of the embedding portion 101 is substantially located at the height H₄ of the casing 4 (FIGS. 2 and 3), and is substantially flush with the opening edge 4e. Specifically, the surface 101f is located between: opening-side surfaces 31u (the upper surfaces in this example) of the core pieces 31 of the magnetic core 3 housed in the winding portions 2a and 2b of the coil 2, the opening-side surfaces 31u being located on the casing 4's opening side; and the opening-side surfaces 2au and 2bu of the winding portions 2a and 2b. Also, the surface 101f is located closer to the opening edge 4e than the opening-side surfaces 31u are (closer to the upper side in this example), and closer to the opening edge 4e than the opening-side surfaces 2au and 2bu are (closer to the lower side in this example). In such a reactor 1, although the height of the casing 4 is relatively small, the amount of filling material 100 is relatively large. The position of the surface 101f may be changed as appropriate by adjusting the filling height H₁₀₀ in the manufacturing process. In the manufacturing process, for example, a material that is flowable enough to fill the casing 4 in an unsolidified state is used as the filling material 100. A liquid surface formed by filling the casing 4 with the material corresponds to the surface 101f when the material is solidified after the casing 4 is filled.

In this example, the surface 101f of the embedding portion 101 and the opening edge 4e of the casing 4 are substantially flush, and therefore a protruding height H₂₀ of the exposed portions 20 from the surface 101f of the embedding portion 101 is smaller than or equal to the width W of the winding wire 2w. The enlarged view shown in the dashed circle in FIG. 2 shows an example in which the protruding height H₂₀ is approximately 50% of the width W of the winding wire 2w.

The protruding height H₂₀ can be changed as appropriate by changing the position of the surface 101f of the embedding portion 101 (the liquid surface in the manufacturing process) as appropriate in a state where the coil 2 is housed in the casing 4, with the height H₄ of the casing 4 being kept constant. For example, it is also possible to set the protruding height H₂₀ to be greater than the width W of the winding wire 2w by setting the surface 101f at a position below the opening edge 4e of the casing 4. If the protruding height H₂₀ is smaller than or equal to the width W of the winding wire 2w as in the example, the height H₄ of the casing 4 enclosing the combined body 10 can be sufficiently large, and the filling height H₁₀₀ of the embedding portion 101 can be increased to a certain extent. For example, as shown in FIG. 2, if the embedding portion 101 has a filling height H₁₀₀ that is sufficient for the entirety of the magnetic core 3 to be embedded therein, it is possible to desirably protect the magnetic core 3 against corrosion or the like. Also, if the filling height H₁₀₀ is relatively large, the distance between the opening-side surfaces 2au and 2bu of the winding portions 2a and 2b of the coil 2 and the surface 101f of the embedding portion 101 can be short. Therefore, such a configuration makes it easier to fill the gaps between the turns 2t with the filling material 100 in the manufacturing process (described later), and improves manufacturability.

### Turn Interposed Portions

The filling material 100 is also interposed between the turns 2t in the exposed portions 20, and thus the turn interposed portions 102 are formed. The turn interposed portions 102 are continuous with and integrated with the embedding portion 101, and have excellent rigidity. Also, as shown in the enlarged view shown in the dashed circle in FIG. 2, the surfaces of all of the turn interposed portions 102 are located above the surface 101f of the embedding portion 101, and therefore a sufficient amount of filling material 100 is present in the gaps between the turns 2t. From the above-described points of view, the turn interposed portions 102 can desirably keep a distance between the turns 2t.

The enlarged view shown in the dashed circle in FIG. 2 shows an example in which the turn interposed portions 102 span the entire range of the width W of the winding wire 2w, i.e., the entire range from the inner circumferential surfaces (the lower side in FIG. 2) to the outer circumferential surfaces (the upper side in FIG. 2) of the winding portions 2a and 2b of the coil 2. Also, FIG. 2 shows an example in which the surfaces of all of the turn interposed portions 102 are located at substantially the same level, and are substantially flush with the opening-side surface 2au of the winding portion 2a. As long as the surfaces of all of the turn interposed portions 102 are located above the surface 101f of the embedding portion 101, at least one of the turn interposed portions 102 is allowed to not span the entire range of the width W of the winding wire 2w, i.e., the positions of the surfaces of the turn interposed portions 102 are allowed to be different. Depending on manufacturing conditions or the like, the surfaces of the turn interposed portions 102 may protrude from the opening-side surfaces 2au and 2bu of the winding portions 2a and 2b. If this is the case, it is easier to recognize that the turn interposed portions 102 are interposed between the turns 2t so as to span the entire range of the turns 2t. Since the turn interposed portions 102 span the entire range of the width W of the winding wire 2w, it can be said that the turn interposed portions 102 are present along the entire circumferences of the winding portions 2a and 2b.

### Constituent Material

The filling material 100 contains a resin. Resin is generally an insulative material. Therefore, as the filling material 100 containing a resin is interposed between the coil 2 and the casing 4 that is made of metal, the filling material 100 improves insulation therebetween. Also, resin is generally more corrosion resistant than metal. Therefore, as the filling material 100 containing a resin covers the magnetic core 3, the magnetic core 3 is more corrosion resistant.

Various kinds of resins that are used as the above-described sealing resin may be used as the resin contained in the filling material 100. In particular, epoxy resins and urethane resins are both preferable because filling with them can be performed in atmospheric air, and thus excellent manufacturability can be achieved. Furthermore, epoxy resins are excellent in terms of heat resistance, insulation properties, weather resistance, and so on. Urethane resins are even better in terms wettability, and are likely to fill gaps.

In particular, it is preferable that the filling material 100 contains an epoxy resin or a urethane resin and a surface energy control additive because such a filling material 100 is excellent in terms of wettability to each of the constituent elements of the reactor 1 such as the coil 2, the magnetic core 3, and the casing 4, as well as interposed members 5 described below and a fixing member (not shown), and are likely to fill gaps, in the manufacturing process. Also, such a filling material 100 is unlikely to split even when it is subjected to thermal cycles or the like. Various kinds of surface energy control additives may be employed. Examples of surface energy control additives that can be used with an epoxy resin or a urethane resin include a silicone type additive. In the solidified filling material 100 included in the reactor 1, the presence of the surface energy control additive can be identified by performing component analysis to determine whether or not an element that is different from the constituent elements of the resin component of the epoxy resin, the urethane resin, or the like is present. In cases where the filling material 100 contains a filler described below, the element that is different from elements of the resin component can be easily identified by performing component analysis after removing the filler from the filling material 100. For example, a surface energy control additive of a silicone type contains an organosilicon compound. For example, if Si is contained as an element that is different from the constituent elements of the resin component of the epoxy resin, the urethane resin, or the like, or if a carbon compound that contains Si is present, it can be determined that this Si is derived from the organosilicon compound.

The amount of surface energy control additive contained in the filling material relative to the resin component can be selected as appropriate within a range that suffices a predetermined degree of wettability. Specifically, wettability may be such that a contact angle with the constituent element of the reactor 1 such as the coil 2 as described above is smaller than or equal to 70°. In particular, in the process of manufacturing the reactor 1 according to the first embodiment, the narrowest gaps among the spaces filled with the filling material 100 are the gaps between the turns 2t. Therefore, it is desirable that the filling material 100 is excellent in terms of wettability to at least the coil 2. It is preferable that a contact angle with the winding wire 2w that constitutes the coil 2, more specifically a contact angle with the insulative coating of enamel or the like that constitutes the outermost surface of the winding wire 2w that is in contact with the filling material 100, is smaller than or equal to 70°.

If the contact angle is too large, there is the risk of a reactor having poor insulation properties or external appearance due to the filling material enclosing bubbles when filling is performed in atmospheric air, for example. If filling is performed at a low speed so as not to enclose bubbles, manufacturability decreases. On the other hand, as the contact angle decreases, wettability improves and the filling material becomes less likely to enclose bubbles even if filling is performed in atmospheric air, and furthermore, even if filling is performed at a high speed. Consequently, substantially no bubbles are present even if filling is performed in atmospheric air, and a reactor 1 that has excellent insulation properties and external appearance can be obtained. In addition, manufacturability is excellent. Therefore, the contact angle is preferably no greater than 65°, or no greater than 60°, and particularly preferably no greater than 50°. Although it is possible to reduce the contact angle by adding a large amount of additive for improving wettability such as a surface energy control additive, a large amount of additive may degrade other properties such as adhesiveness. Therefore, the contact angle is preferably greater than or equal to 30°, and particularly preferably greater than or equal to 45°. The amount of surface energy control additive contained in the filling material may be adjusted so that the contact angle is no greater than 70°. The contact angle here is a value when the resin composition containing the surface energy control additive has not been solidified, and is in a flowable state. If an epoxy resin or a urethane resin is contained, the contact angle is measured at approximately 45° C., for example.

The filling material 100 may contain a filler with excellent thermal conductivity or a filler with excellent insulation properties. If the filling material 100 contains a filler with excellent thermal conductivity, especially a filler with thermal conductivity that is greater than or equal to 2 W/m·K, the thermal conductivity of the filling material 100 can be improved and the filling material 100 may be used as a heat dissipation path between the coil 2, the magnetic core 3, and the casing 4 that is made of metal. In particular, a filling material 100 with a thermal conductivity that is greater than or equal to 1 W/m·K, or furthermore greater than or equal to 1.5 W/m·K, or greater than or equal to 2 W/m·K is preferable because a reactor 1 with excellent heat dissipation properties can be obtained. If the filling material 100 contains a filler with excellent insulation properties, insulation between the coil 2, the magnetic core 3, and the casing 4 that is made of metal can be improved.

The above-described filler may be made of, for example, a nonmetallic inorganic material, e.g., a ceramic containing an oxide such as alumina, silica, or a magnesium oxide, a nitride such as a silicon nitride, an aluminum nitride, or a boron nitride, or a carbide such as a silicon carbide, or made of a material constituted by nonmetallic elements, such as carbon nanotubes. A ceramic that is excellent in terms of both thermal conductivity and excellent insulation properties can be desirably used.

If the filling material 100 contains the above-described filler, the viscosity of the filling material 100 is likely to be large. However, if the filling material 100 contains a resin component that has a sufficiently small contact angle (no greater than 70°) and excellent wettability to the constituent elements such as the coil 2 of the reactor 1, wettability is excellent even though viscosity is large due to the filler being contained. Therefore, areas that cannot be easily filled with conventional sealing resins, such as narrow spaces such as the gaps between the turns 2t, and a gap located close to the bottom portion 41 of the casing 4, can be filled with the filling material 100 at a high speed in atmospheric air. Furthermore, areas that are narrow and cannot be easily supplied with the filling material 100, such as gaps between the turns 2t in the exposed portions 20, can also be filled with the filling material 100 due to capillary action or the like. In this example, the distance from the surface 101f of the embedding portion 101 to the farthest positions of the exposed portions 20 (the opening-side surfaces 2au and 2bu of the winding portions 2a and 2b of the coil 2) is relatively short (no greater than the width W of the winding wire 2w in this example), and therefore the gaps between the turns 2t in the exposed portions 20 can be easily filled with the filling material 100. Also, in the casing 4 in this example, the bottom portion 41 side gap r (FIG. 3) is larger than the opening side gap c as described above, and therefore filling with the filling material 100 can be easily performed. For example, filling material 100 introduced to the bottom portion 41 side can flow in the axial direction of the winding portions 2a and 2b on the bottom portion 41 side.

### Modifications of Main Members, Etc., and Other Constituent Members Coil

A coil 2 that has only one winding portion may be provided. If this is the case, the magnetic core 3 may have a well-known shape, such as the shape of a so-called EE core, ER core, or EI core.

The winding wire 2w may be a coated round wire that includes a round wire conductor and an insulative coating. Gaps between turns of a coated round wire are larger than those between the turns of an edgewise coil in many areas, and the amount of each turn interposed portion 102 can be easily increased.

The winding portion may have a cylindrical shape (with a circular end surface). If this is the case, if the coil 2 is housed in the casing 4 such that the axis of the wiring portion extends in parallel with the inner bottom surface 41i of the casing 4, relatively large gaps can be provided between the coil 2 and the bottom portion 41 side and the opening side of the casing 4, and the gaps can be easily filled with the filling material 100.

### Magnetic Core

Each of the core pieces 31 in this example has a rectangular parallelepiped shape with rounded corners as shown in FIG. 3, and each of the gap members 31g is a rectangular flat plate with rounded corners. Each of the core pieces 32 in this example includes a rectangular parallelepiped block with rounded corners, and a pair of protruding portions that protrude from the block toward the coil 2. Each protruding portion has the same shape as the core pieces 31.

The above-described block of each core piece 32 is configured such that, as shown in FIG. 2, the surface thereof that faces the inner bottom surface 41i of the casing 4 (the lower surface) protrudes further than the surfaces that face the inner bottom surface 41i (the lower surfaces) of the stacked members including the core pieces 31. In a state where the coil 2 and the magnetic core 3 are attached to each other, the lower surfaces of the above-described blocks and the surfaces (the lower surfaces) that face the inner bottom surface 41i, of the winding portions 2a and 2b of the coil 2 are substantially flush with each other, and are supported by the inner bottom surface 41i. Therefore, the combined body 10 can be stably housed in the casing 4, and has excellent heat dissipation properties because the above-described blocks of the core pieces 32 conduct heat to the inner bottom surface 41i.

The block of one core piece 32 that is located closer to the coupling portion 2r of the coil 2 than the other can be made to protrude toward the opening side of the casing 4. For example, the block may have a step-like shape, the coupling portion 2r may be housed in a lower step portion, and an upper step portion that forms the opening-side surface 32u and the opening-side surfaces 2au and 2bu of the winding portions 2a and 2b of the coil 2 may be substantially flush with each other.

The number, shape, dimension, composition, and so on of the core pieces 31 and 32 and the gap members 31g may be changed as appropriate. For example, the core pieces 32 may have a rectangular parallelepiped shape, and the above-described protruding portions may serve as the core pieces 31. The gap members 31g may be replaced with air gaps. Also, the gap members 31g may be omitted. The core pieces and the gap members can be easily attached if they are fixed using an adhesive or the like.

### Casing

The casing 4 may be an integrally formed member that is made of a uniform constituent material as described above. Alternatively, the bottom portion 41 and the side wall portion 42 may be separate members configured to be combined into one piece. For example, the bottom portion 41 on which the combined body 10 is mounted may be made of a metal plate, the side wall portion 42 that surrounds the combined body 10 may be a molded member that is made of an insulative material such as resin, and the bottom portion 41 and the side wall portion 42 may be combined.

### Other Constituent Members

### Insulating Layer

The reactor 1 in this example includes an insulating layer 6 between the winding portions 2a and 2b of the coil 2 and the inner bottom surface 41i of the casing 4. The insulating layer 6 improves insulation between the coil 2 and the bottom portion 41 of the casing 4 that is made of metal, and is made of an insulative material. Notably, the insulating layer 6 contains an insulative material that has a thermal conductivity that is greater than or equal to 2 W/m·K, and thus has excellent thermal conductivity, so that heat from the coil 2 can be easily conducted to the casing 4 that is made of metal. The material, thickness (e.g. no less than 30 μm and no greater than 2 mm, or furthermore no greater than 1 mm, no greater than 0.5 mm, or no greater than 0.1 mm), formation area (above or at the same level as the surface of the coil 2 facing the inner bottom surface 41i of the casing 4, and below or at the same level as the inner bottom surface 41i), and so on of the insulating layer 6 may be selected so that the insulating layer 6 has desired insulation properties and heat dissipation properties. As shown in FIG. 1, the insulating layer 6 in this example has approximately the same size as the surfaces that face the inner bottom surface 41i, of the coil 2 and the magnetic core 3 (the blocks of the core pieces 32).

The constituent material of the insulating layer 6 may be heat resistant to the extent that the insulating layer 6 does not soften at the maximum temperature that can be reached during the use of the reactor 1, have excellent electrical insulation properties, and also have high thermal conductivity. For example, a resin material may contain a resin such as a thermosetting resin, a thermoplastic resin, a moisture curable resin, or a room temperature curable resin, and the above-described filler that has high thermal conductivity. Examples of thermosetting resins include an epoxy resin, a silicone resin, a urethane resin, an unsaturated polyester, and so on. Examples of thermoplastic resins include a polyphenylene sulfide (PPS) resin, liquid crystal polymer (LCP), a polyamide (PA) resin, polyamideimide, polyimide, and so on.

It is preferable that the constituent material of the insulating layer 6 contains an adhesive component because such an insulating layer 6 firmly fixes the combined body 10 to the inner bottom surface 41i of the casing 4. Specifically, a curable adhesive that mainly contains an epoxy resin, a silicone resin, or a urethane resin may be employed, for example.

The insulating layer 6 may be formed using a sheet-shaped member, for example, or by applying or spraying a material such as the above-described resin material onto the inner bottom surface 41i.

### Interposed Member

The reactor 1 (the combined body 10) in this example includes an interposed member 5 that is interposed between the coil 2 and the magnetic core 3 as shown in FIG. 4 to improve insulation therebetween. The interposed member 5 in this example is formed by combining a pair of divided members 5a and 5b that are separated from each other in the axial direction of the winding portions 2a and 2b of the coil 2. Each of the divided members 5a and 5b includes inner interposed portions 51 that are interposed between the winding portions 2a and 2b and portions of the magnetic core 3 housed in the winding portions 2a and 2b, and an end surface interposed portion 52 that is interposed between the end surfaces of the winding portions 2a and 2b and an inner end surface 32e of a core piece 32. The inner interposed portions 51 in this example include a plurality of plate pieces that are separated from each other so as to surround the stacked members composed of the core pieces 31 and the gap members 31g. The end surface interposed portion 52 is a frame plate portion that has two through holes 52h into which the pair of protruding portions of a U-shaped core piece 32 are inserted. The shape of the interposed member 5 is an example and may be changed as appropriate. The interposed member 5 is made of an insulative material such as any kind of resin.

### Coated Core Members

Instead of the above-described interposed members 5, coated core members may be employed, in which the core pieces 31 and 32 of the magnetic core 3, and the stacked members including the core pieces 31 and the gap members 31g, are coated by an insulative material such as a resin. Although the coated core members and the above-described interposed members 5 may be omitted, these members improve insulation between the coil 2 and the magnetic core 3.

### Fixing Member

A fixing member (not shown) that fixes the combined body 10 in the casing 4 may be provided. The fixing member may be a band-shaped member. The band-shaped member may be placed on and pressed against the opening-side surfaces 32u of the core pieces 32 that are included in the magnetic core 3 and protrude from the coil 2, and fixed to the casing 4 using a fastening member such as a bolt (not shown). The band-shaped member may be made of a high-strength material such as steel.

### Sensors

Sensors (not shown) that measure physical amounts regarding the reactor 1, such as a temperature sensor, a current sensor, a voltage sensor, and a magnetic flux sensor may be provided.

### Manufacturing Method

The reactor 1 is manufactured in the following manner, for example. First, the coil 2, the magnetic core 3, and if appropriate, the interposed members 5 or the like are attached to each other to form the combined body 10. This combined body 10 is put into the casing 4. The metal terminal part can be easily attached to an end portion of the winding wire 2w before the combined body 10 is put into the casing 4 because the end portion of the winding wire 2w is not surrounded by the casing 4 and sufficient work space can be secured. After the combined body 10 is put into the casing 4, the casing 4 is filled with the filling material 100 in an unsolidified state in atmospheric air, preferably at a high speed, and then the filling material 100 is solidified. Thus, the reactor 1 can be obtained.

### Application

The reactor 1 according to the first embodiment can be used in various converters such as an on-board converter (typically a DC-DC converter) that is mounted on vehicles such as a hybrid vehicle, a plug-in hybrid vehicle, an electric vehicle, and a fuel cell vehicle, and a converter for an air conditioner, and in constituent components of a power converter device.

### Actions and Effects

The reactor 1 according to the first embodiment has excellent insulation properties, and is also downsized for the following reasons.

### —Downsizing

Compared to the combined body 10 housed in the casing 4, the height H₄ of the casing 4 is small, and the height of the reactor 1 does not depend on that of the casing 4. In this example, the height of the reactor 1 is substantially the same as the height of the combined body 10 (the height H₂ of the coil 2) in a state where the metal terminal part is attached to an end portion of the winding wire 2w, and thus the height of the reactor 1 including the metal terminal part is small.

### —Insulation Properties

The filling material 100 (the embedding portion 101) is interposed between the combined body 10 and the casing 4 that is made of metal, and insulation between the coil 2 and the casing 4 is improved. Since the embedding portion 101 surrounds the outer circumferential surface of the coil 2, a sufficient insulation distance can be secured between the coil 2 and the casing 4 along the entire circumference of the combined body 10. In addition, although the winding portions 2a and 2b of the coil 2 are provided with the exposed portions 20 that protrude from the opening edge 4e of the casing 4, the turn interposed portions 102 are provided between the turns 2t in the exposed portions 20. The turn interposed portions 102 are continuous with the embedding portion 101, and thus have excellent rigidity. Also, the surfaces of all of the turn interposed portions 102 are located above the surface 101f of the embedding portion 101, and thus a sufficient amount of turn interposed portion 102 is interposed between each turn 2t. As in this example, if the turn interposed portions 102 are present in the entire area between each turn 2t in the exposed portions 20, the filling material 100 is continuous along the circumferential direction of the winding portions 2a and 2b, and thus rigidity is further improved. For the above-described reasons, the turn interposed portions 102 can easily keep the distance between the turns 2t, and prevent turns 2t that are adjacent to each other from coming into contact with each other even when vibrations are generated during the use of the reactor 1. As in this example, if the turn interposed portions 102 are present in the entire area between each turn 2t in the exposed portions 20, turns 2t that are adjacent to each other are prevented from coming into contact with each other in substantially all cases. Therefore, insulation between the turns 2t is further improved.

In addition, the reactor 1 has excellent heat dissipation properties as well. The turn interposed portions 102 are provided in the turns 2t in the exposed portions 20 of the coil 2, and the turn interposed portions 102 are continuous with the embedding portion 101 in which a portion of the combined body 10 is embedded. Therefore, heat from the coil 2 can be conducted to the installation target via the turn interposed portions 102, the embedding portion 101, and the casing 4. In this example, the reactor 1 has further improved heat dissipation properties also because the casing 4 is made of metal and the insulating layer 6 that has excellent thermal conductivity is interposed between the coil 2 and the casing 4. If the insulating layer 6 contains an adhesive component and adheres to the coil 2 and the casing 4, heat dissipation properties can be further improved. If the filling material 100 contains the above-described filler that has high thermal conductivity, heat dissipation properties can be further improved. If the exposed portions 20 are cooled using a fan or the like, heat dissipation properties can be further improved.

Through the manufacturing process, such a reactor 1 can be manufactured with high productivity by using the filling material 100 that contains a resin component whose contact angle with the constituent elements of the reactor 1 such as the coil 2 is no greater than 70° as described above. This is because such a filling material 100 has excellent wettability to the constituent elements of the reactor 1 such as the coil 2, and the filling material 100 is less likely to enclose bubbles even in atmospheric air, and filling can be performed in a desirable manner. If filling is performed in atmospheric air at a high speed, manufacturability can be further improved. Even in such a case, if the contact angle is sufficiently small as described above, the filling material 100 is unlikely to enclose bubbles. If the filling material 100 contains a resin component that has excellent wettability, if viscosity increases due to the above-described filler being contained, the above-described filler does not have an influence on wettability, and filling can be performed in a desirable manner. Therefore, it is possible to prevent insulation properties from degrading, and the external appearance from being poor due to bubbles being contained in the filler 100, and thus the reactor 1 can have excellent insulating properties as well as an excellent appearance.

### Test Example 1

Materials that have different contact angles were prepared as filling materials for filling the casing, and how the filling materials filled the casing was examined.

In this test, a reactor that includes: a coil that includes a pair of winding portions that are constituted by edgewise coils of a coated flat wire; a magnetic core that is formed so as to have a ring shape by combining a plurality of core pieces; interposed members that are made of resin and are interposed between the coil and the magnetic core; a casing that is made of an aluminum alloy and houses a combined body that includes the elements above; and a filling material that fills the casing, was manufactured (see FIG. 1). The coated flat wire is an enameled wire that includes a copper conductor and an insulative coating that is made of polyimide. The core pieces are powder compacts formed using a soft magnetic powder such as a pure iron powder.

The height of the casing was adjusted so that, in a state where the combined body is housed in the casing, an opening side area of the coil with respect to the opening of the casing protrudes from the opening edge of the casing, and this protruding height is no greater than the width of the coated flat wire.

Although the combined body and the casing were fixed by interposing an insulating layer that includes an insulative material that has a thermal conductivity that is greater than or equal to 2 W/m·K, and an adhesive component, between the combined body and the inner bottom surface of the casing, the insulating layer may be omitted.

A base resin modified such that the contact angle thereof with the coated flat wire is no greater than 70° was prepared by adding a silicone type surface energy control additive to an epoxy resin. In this example, the amount of surface energy control additive was adjusted so that the contact angle at 45° C. is no less than 40° and no greater than 50°. Note that the contact angle with the core pieces, which are powder compacts, and the casing, which is made of an aluminum alloy, was found to be no greater than 70°. Commercially available resin additives can be used as the above-described surface energy control additive. For example, a surface control additive manufactured by Kyoeisha Chemical Co., Ltd. (product name: POLYFLOW), a surface control additive manufactured by Evonik Japan Co., Ltd. (product name: TEGO Glide), or the like may be used. The amount of additive is, for example, no less than 0.01 parts by weight and no greater than 1.5 parts by weight per 100 parts of epoxy resin.

The above-described base resin to which an alumina filler was added was used as the filling material. The average particle diameter of the alumina filler was 20 μm, and the alumina filler was added so that the concentration of the alumina filler in the filling material was 60% (v/v). The casing was filled with the filling material thus prepared, up to near the opening edge of the casing in atmospheric air, so that the filling height is substantially equal to the depth of the casing. In this example, in an opening side area of the coil with respect to the opening of the casing, the protruding height from the liquid surface of the filling material is approximately 50% of the width W of the coated wire. After filling was complete, the filling material was heated to a predetermined temperature and was thereby solidified.

In the reactor thus obtained, portions of the winding portions of the coil protrude from the opening edge of the casing, and a portion of the combined body surrounded by the casing is mainly covered by the filling material. The surface of the portion (the embedding portion) of the filling material, in which a portion of the combined body is embedded, was visually checked, and it was found that, although filling was performed in atmospheric air, there were substantially no bubbles or the like, and the reactor had an excellent external appearance.

In a vertical cross section of the reactor thus obtained, along a plane that is parallel with the axial direction of the winding portions of the coil, the gaps between the turns in the portions (the exposed portions) of the winding portions of the coil, which protrude from the opening edge of the casing, were checked. As a result, it was found that all of the gaps between the turns, from the inner circumferential surfaces to the outer circumferential surfaces of the winding portions, were filled with the filling material. It was found that the portions of the filling material (the turn interposed portions) interposed between the turns were continuous with the embedding portion, and that the surfaces of the turn interposed portions were located above the surface of the embedding portion.

This means that, by using a filling material that has excellent wettability to the constituent elements of the reactor (the filling material in this example includes a resin component whose contact angle is no greater than 70°), it is possible to fill the gaps between the turns with the filling material even if the reactor has a configuration in which portions of the winding portions of the coil protrude from the opening edge of the casing and from the surface of the filling material (the embedding portion). In particular, if the filling material specified above is used, the filling material is less likely to enclose bubbles and filling can be performed in a desirable manner, even with respect to areas that are narrow and cannot be easily supplied with a filling material when filling is performed, such as the gaps between the turns in the exposed portions, and even if filling was performed in atmospheric air.

A comparative reactor that has the same basic structure as the above-described reactor was manufactured using a silicone resin (a commercial available product) instead, as a filling material. The silicone resin thus prepared has a contact angle of 75° (at approximately 45° C.) with a coated flat wire, which is greater than 70°. The casing was filled with the silicone resin thus prepared, while evacuation was performed. In a vertical cross section, as described above, of the reactor thus obtained, the gaps between the turns in the exposed portions of the winding portions of the coil, which protrude from the opening edge of the casing, were checked. As a result, it was found that substantially none of the gaps between the turns were filled with the filling material.

As described above, it was confirmed that, even when the reactor has a configuration in which portions of the winding portions of the coil protrude from the opening edge of the casing, and furthermore, even when filling is performed in atmospheric air, if a filling material containing a resin component that has a sufficiently small contact angle is used, the filling material can even fill areas that protrude (are separated) from the surface of the filling material filling the casing, and that are narrow, such as the gaps between the turns. Also, since the above-described turns can be filled with the filling material, the reactor has excellent insulation properties, and since the casing is relatively low, a downsized reactor can be obtained.

The present application is not limited to these examples, and is specified by the scope of claims. All changes that come within the meaning and range of equivalency of the claims are intended to be embraced therein.

1. A reactor comprising:
a coil that includes a winding portion that is constituted by a plurality of turns formed by spirally winding a winding wire;
a magnetic core that includes a portion that is located in the winding portion;
a casing that houses a combined body that includes the coil and the magnetic core; and
a filling material that contains resin and fills the casing,
wherein the winding portion includes an exposed portion that protrudes from an opening edge of the casing,
the filling material includes an embedding portion in which a portion of the combined body is embedded and that has a surface located below or at the same level as the opening edge of the casing, and turn interposed portions that are interposed between the turns in the exposed portion, and
surfaces of the turn interposed portions are located above a surface of the embedding portion.

2. The reactor according to claim 1, wherein a protruding height of the exposed portion relative to the surface of the embedding portion is no greater than a width of the winding wire.

3. The reactor according to claim 1, wherein the filling material contains an epoxy resin or a urethane resin, and a surface energy control additive.

4. The reactor according to claim 1, wherein a gap between an outer circumferential surface of the winding portion and a bottom portion side area of the casing is wider than a gap between the outer circumferential surface of the winding portion and an opening side area of the casing.

5. The reactor according to claim 1, further comprising an insulating layer that is interposed between the wiring portion and an inner bottom surface of the casing, and that contains an insulative material that has a thermal conductivity that is greater than or equal to 2 W/m·K.

6. The reactor according to claim 2, wherein the filling material contains an epoxy resin or a urethane resin, and a surface energy control additive.

7. The reactor according to claim 2, wherein a gap between an outer circumferential surface of the winding portion and a bottom portion side area of the casing is wider than a gap between the outer circumferential surface of the winding portion and an opening side area of the casing.

8. The reactor according to claim 3, wherein a gap between an outer circumferential surface of the winding portion and a bottom portion side area of the casing is wider than a gap between the outer circumferential surface of the winding portion and an opening side area of the casing.

9. The reactor according to claim 2, further comprising an insulating layer that is interposed between the wiring portion and an inner bottom surface of the casing, and that contains an insulative material that has a thermal conductivity that is greater than or equal to 2 W/m·K.

10. The reactor according to claim 3, further comprising an insulating layer that is interposed between the wiring portion and an inner bottom surface of the casing, and that contains an insulative material that has a thermal conductivity that is greater than or equal to 2 W/m·K.

11. The reactor according to claim 4, further comprising an insulating layer that is interposed between the wiring portion and an inner bottom surface of the casing, and that contains an insulative material that has a thermal conductivity that is greater than or equal to 2 W/m·K.
